(19) United States
(12) Patent Application Publication
(10) Pub. No.: US 2005/0253958 A1
(43) Pub. Date: Nov. 17, 2005

(54) INTEGRATED IMAGE CAPTURING DEVICE

(76) Inventor: Chih-Cheng Hsieh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/905,000

(22) Filed: Dec. 9, 2004

(30) Foreign Application Priority Data
May 14, 2004 (TW) 093113713

(51) Int. Cl. H04N 5/222

(52) U.S. Cl. 348/370

(57) ABSTRACT

An integrated image fetching device integrates a control circuit and a CMOS sensor on a substrate. The control circuit includes a photometry module used to control a detecting flash, to receive a light signal, and detect the brightness of the light signal. The control circuit also includes a calculating unit used to calculate the magnitude and the period of a flash of a strobe and an exposure parameter, a strobe control module used to control the strobe according to the calculated results of the calculating unit, and an exposure control module used to control an exposure module according to the exposure parameter.

### BACKGROUND OF THE INVENTION

1. Field of the Invention

The present invention relates to an image capturing device, and more particularly, to an integrated image capturing device having an integrated control circuit and sensor.

2. Description of the Prior Art

A camera is a very popular device for recording people's lives. Recently, digital cameras have become especially popular. A digital camera includes a strobe for providing a light source in the dark and a shutter for controlling the exposure time. Cooperation between the shutter and the strobe relates to the quality of pictures.

Please refer to FIG. 1. FIG. 1 illustrates a digital camera 10 according to the prior art. The digital camera 10 comprises a shutter 14, a lens 16, an optical sensor 18, a strobe 12, a memory 24, and a control chip 18. The optical sensor 18 is a CCD sensor or a CMOS sensor. The time when the shutter 14 is open corresponds to the exposure time of the camera 10. While the shutter 14 is open, the objects outside will form an image on the optical sensor 18 through the lens 16. The optical sensor 18 records the image and stores it in the memory 24. If there is not enough ambient light present, the strobe 12 will emit a flash while the shutter 14 is open. The timing of the strobe 12 and the shutter 14 is controlled by the control chip 18.

Most digital cameras are equipped with CCD sensors for serving as the optical sensors, but the manufacturing process of the CCD sensor differs from that of the CMOS process. Therefore, a CCD sensor and a control chip fabricated in the CMOS technology cannot be integrated together. As for another kind of optical sensor, the CMOS sensor, it can also be used in a digital camera to sense images. However, the CMOS sensor has the same manufacturing process as the CMOS circuit, so the CMOS sensor can easily be integrated with its control circuitry. In the prior art digital camera with a CMOS sensor inside, the CMOS sensor and the control circuitry, seen as two independent modules, are still connected by wires, and are not integrated in one chip.

The digital camera produced by packaging two independent modules, a CMOS sensor and control circuitry, through wires has the following disadvantages: 1. The procedure of packaging two independent modules is more complicated. 2. A shutter, a strobe and an optical sensor are not effectively controlled by an integrated chip, so the transmission time between different modules creates a minimum amount of time needed for successive exposure intervals. 3. That the control circuitry and the optical sensor are not integrated together increases the production time and complexity.

### SUMMARY OF INVENTION

It is therefore an objective of the claimed invention to provide an integrated image capturing chip in order to solve the above-mentioned problems.

According to the claimed invention, an integrated image capturing chip used in an image capturing device equipped with a strobe comprises a substrate, a CMOS sensor mounted on the substrate for receiving an image signal, and a control circuit mounted on the substrate. The control circuit comprises a photometry module for receiving a light signal of the image capturing device and detecting the photometry of the light signal, a calculating unit connected with the photometry module for calculating a control parameter of a flash according to the photometry of the light signal, and a strobe control module for controlling the flash according to the control parameter.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a digital camera according to the prior art.

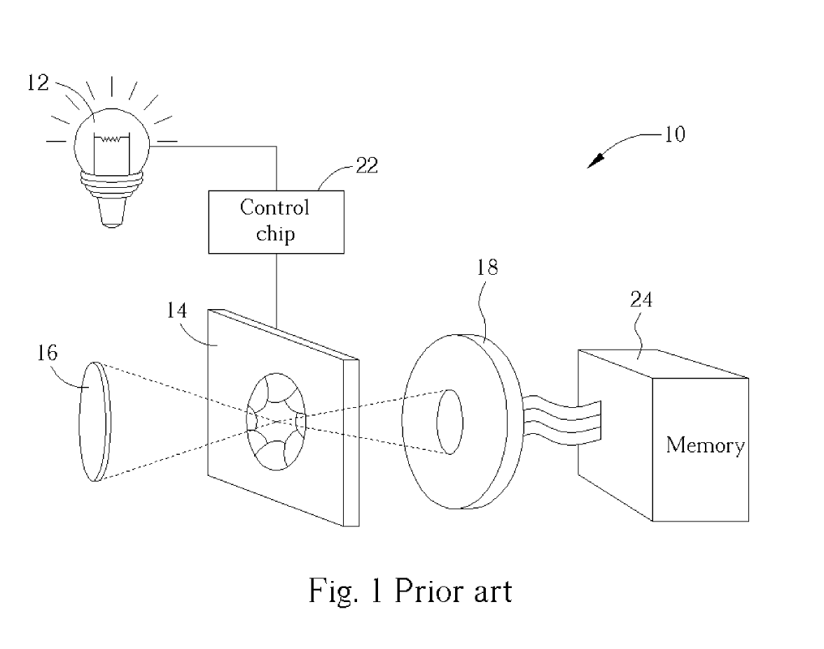

FIG. 2 illustrates an image capturing chip of the first embodiment of the present invention.

FIG. 3 illustrates an image capturing chip of the second embodiment of the present invention.

FIG. 4 illustrates an image capturing device of the third embodiment of the present invention.

FIG. 5 illustrates an image capturing device of the fourth embodiment of the present invention.

FIG. 6 illustrates the image capturing device of the fifth embodiment of the present invention.

FIG. 7 illustrates a method of controlling the strobe, shutter and diaphragm used in an integrated image capturing device according to the present invention.

### DETAILED DESCRIPTION

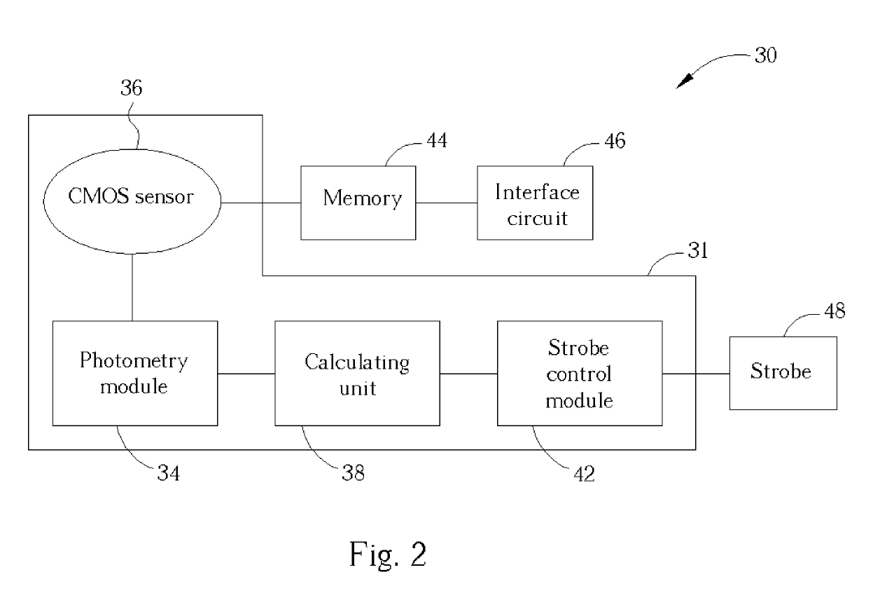

Please refer to FIG. 2. FIG. 2 illustrates an image capturing chip 30 of the first embodiment of the present invention. The image capturing chip 30 comprises a substrate 31, a photometry module 34, a CMOS sensor 36, a calculating unit 38, a strobe control module 42, a memory 44, and an interface circuit 46. The image capturing chip 30 takes advantage of the property that a CMOS sensor and CMOS circuitry have the same manufacturing process. Therefore, the circuitry including the photometry module 34, the calculating unit 38 and the strobe control module 42 as well as the CMOS sensor 36 are integrated together on the substrate 31. The photometry module 34 is used to sense ambient light to determine if the light is strong enough and if the strobe needs to emit the flash. After the photometry module 34 detects the brightness, then it sends a detecting result to the calculating unit 38. The calculating unit calculates the flashing period, the photometry, and the flash frequency of the strobe 48 according to the detecting result of the photometry module 34, and sends the calculated result to the strobe control module 42. The strobe control module 42 connected to the strobe 48 controls the strobe 48 to flash.

The CMOS sensor 36 receives the captured image signal, which is then stored in the memory 44. The interface circuit 46 is used to output the data of the memory 44 to other devices. The memory 44 and the interface circuit 46 of the FIG. 2 are not mounted on the substrate 31. However, a designer can integrate both the memory 44 and the interface circuit 46 on the substrate 31, or integrate one of the memory 44 and the interface circuit 46 on the substrate 31.

The calculating unit calculates parameters such as strength, period, or frequency of the strobe according to configurations set in the digital camera and according to conditions of the captured background. For example, if light of the captured background is not strong enough or if the configuration is set as “forced to flash”, the strobe control module 42 is ready to drive the strobe. Different strobe modes are applied to different environments. The calculating unit 38 refers to a predetermined configuration and the detected result of the photometry module 34 to determine the most appropriate strobe mode.

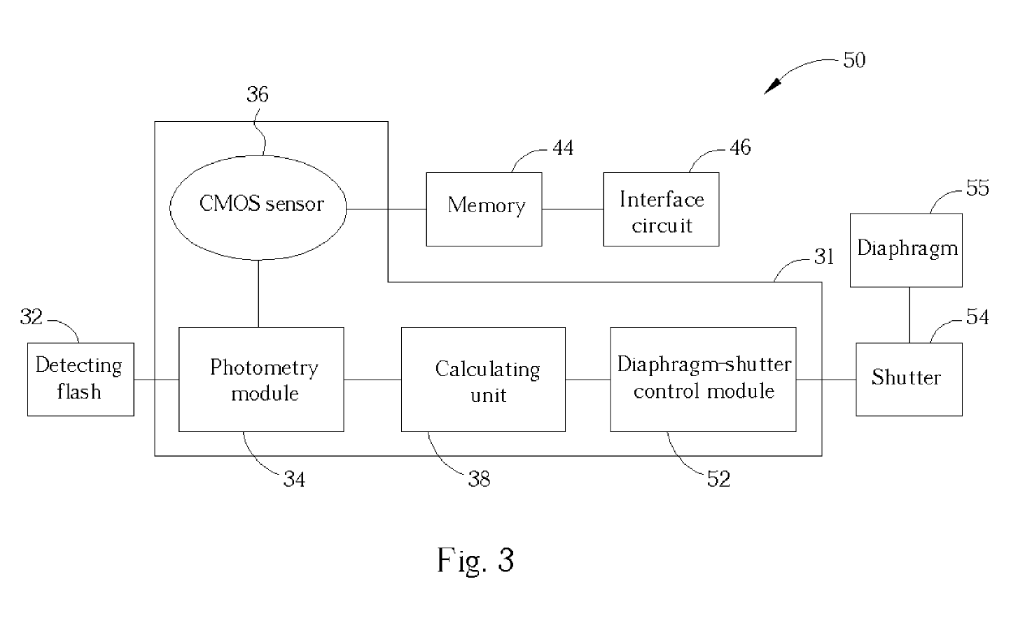

Please refer to FIG. 3. FIG. 3 illustrates an image capturing chip 50 of the second embodiment of the present invention. The image capturing device 50 comprises a substrate 31, a detecting flash 32, a photometry module 34, a CMOS sensor 36, a calculating unit 38, a diaphragm-shutter control module 52, a memory 44, an interface circuit 46, a diaphragm 55 and a shutter 54. The circuitry including the photometry module 34, the calculating unit 38 and the diaphragm-shutter control module 52 as well as the CMOS sensor 36 are integrated together on the substrate 31.

The photometry module 34 and the calculating unit 38 will cooperate to determine the exposure, which is controlled by the diaphragm 55 and the shutter 54. When the control circuit 30 is operating, the detecting flash 32 emits a detecting light to determine the reflection rate of the captured background. Then, the photometry module 34 receives reflected light from some objects of the captured background and detects the photometry of the reflected light. The calculating unit 38 calculates the size of the diaphragm 55 and the open period of shutter 54 according to the photometry of the reflected light and sends the calculation result to the diaphragm-shutter control module 52 to control the diaphragm 55 and the shutter 54.

Moreover, the diaphragm 55 and the shutter 54 can also change the effects of the photos. For example, a larger diaphragm results in the visual effect of a shorter background depth. The calculating unit 38 will refer to a user's request or the configuration of the camera to obtain a proper parameter for the diaphragm-shutter control module 52. The most important fact is that because the present invention integrates the control circuit and the CMOS sensor together, transmission of electronic signals between each unit is fast and efficient. Especially in the case of high-speed successive photographing, the shutter 54 needs shorter response time and control time intervals. The present invention can easily promote the speed of successive photographing.

The memory 44 and the interface circuit 46 of the FIG. 3 are not mounted on the substrate 31. However, a designer can integrate both the memory 44 and the interface circuit 46 on the substrate 31, or integrate one of the memory 44 and the interface circuit 46 on the substrate 31. In addition, in the embodiment, the image capturing device, the diaphragm, and the shutter are kinds of exposure devices. The open period of the shutter determines the exposure time of the CMOS sensor, and the size of the diaphragm determines the light amount of the CMOS sensor. In the image capturing device, an exposure control module connected to the calculating unit 38 can control an exposure module to handle the exposure of the CMOS sensor. The calculating unit 38 is further used to calculate a control parameter according to the detection result of the photometry module 34, and the exposure control module controls the exposure module according to the control parameter.

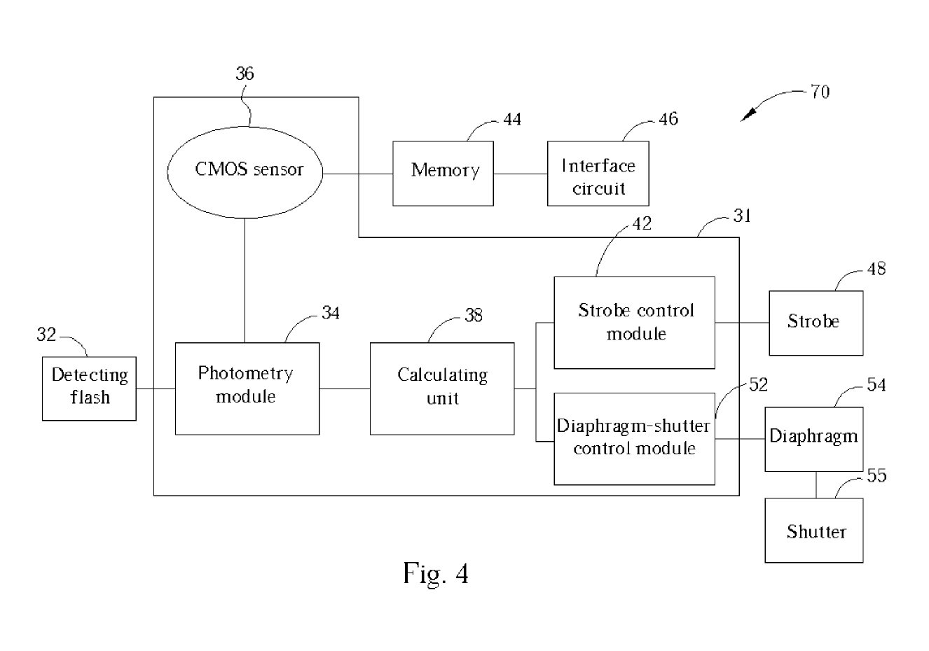

Please refer to FIG. 4. FIG. 4 illustrates an image capturing device 70 of the third embodiment of the present invention. The image capturing device 70 comprises a substrate 31, a detecting flash 32, a photometry module 34, a CMOS sensor 36, a calculating unit 38, a diaphragm-shutter control module 52, a strobe control module 42, a memory 44, an interface circuit 46, a strobe 48, a diaphragm 55, and a shutter 54. The circuitry including the photometry module 34, the calculating unit 38, the strobe control module 42, and diaphragm-shutter control module 52 as well as the CMOS sensor 36 are integrated together on the substrate 31.

In this embodiment, the photometry module 34 is used not only to detect the light of the captured background, but also to detect the reflected light from the detecting flash 32 emitting to some objects in the background. The calculating unit 38 calculates the parameters of the strobe 48, the shutter 54, and the diaphragm 55 according to the detected light of the captured background and the detected light of the reflected light. When taking pictures, the strobe 48, the shutter 54 and the diaphragm 55 must cooperate together to obtain the best quality of the pictures. In addition, the calculating unit 38 refers to the configuration of the camera to obtain the parameters of the strobe 48, the shutter 54 and the diaphragm 55 and sends the calculation result to the diaphragm-shutter control module 52 to control the diaphragm 55 and the shutter 54.

Since the present invention integrates the control circuit and the CMOS sensor together, transmission of electronic signals between each unit is fast and efficient. Especially in the case of high-speed successive photographing, the shutter 54 and the strobe 48 need shorter response time and control time intervals. The present invention can easily promote the speed of successive photographing.

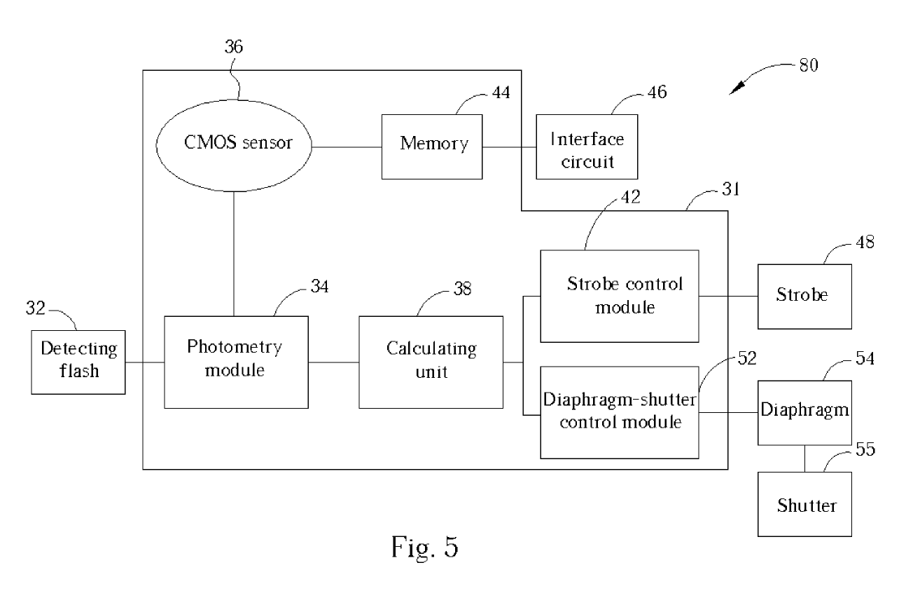

Please refer to FIG. 5. FIG. 5 illustrates an image capturing device 80 of the fourth embodiment of the present invention. The image capturing device 80 comprises a substrate 31, a detecting flash 32, a photometry module 34, a CMOS sensor 36, a calculating unit 38, a diaphragm-shutter control module 52, a strobe control module 42, a memory 44, an interface circuit 46, a strobe 48, a diaphragm 55, and a shutter 54. The circuitry including the photometry module 34, the calculating unit 38, the strobe control module 42, diaphragm-shutter control module 52, and the memory 44 as well as the CMOS sensor 36 are integrated together on the substrate 31. The operation principle of the image capturing chip 80 in FIG. 5 is the same as that of the image capturing device 70 in FIG. 4.

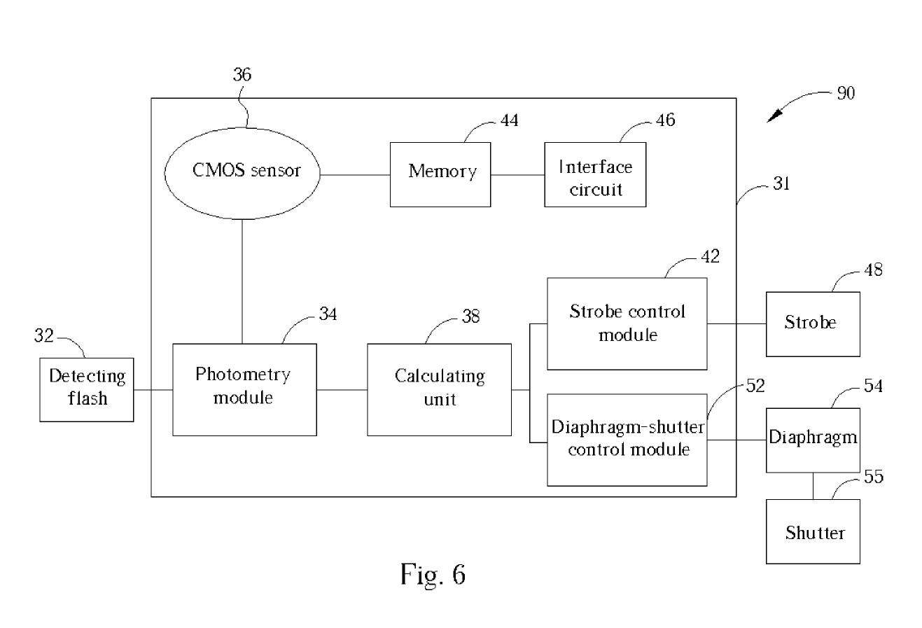

Please refer to FIG. 6. FIG. 6 illustrates the image capturing device 90 of the fifth embodiment of the present invention. In the embodiment of the image capturing device 90, the photometry module 34, the calculating unit 38, the strobe control module 42, the diaphragm-shutter control module 52, the memory 44, and the interface circuit 46 as well as the CMOS sensor 36 are integrated on the substrate 31. The operation principle of the image capturing device 90 in FIG. 6 is the same as that of the image capturing device 70 in FIG. 4.

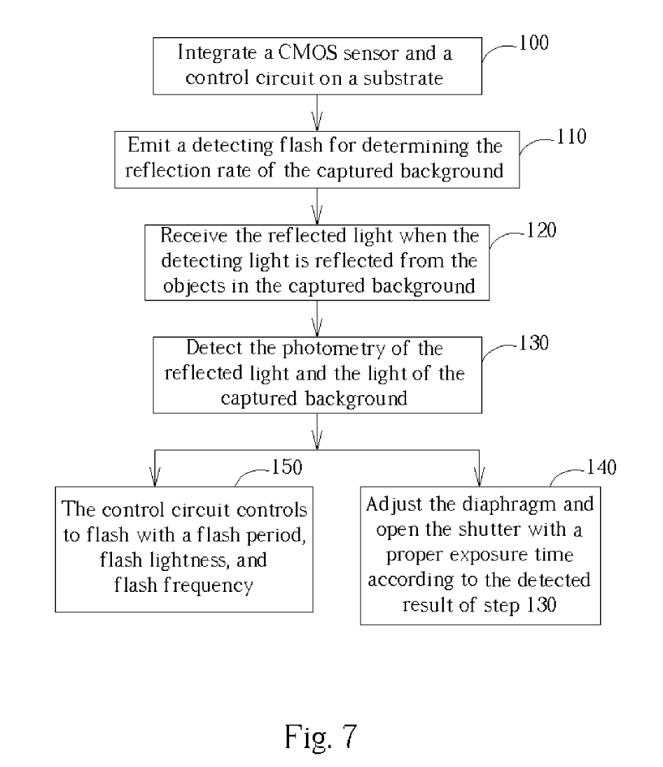

Please refer to FIG. 7. FIG. 7 illustrates a method of controlling the strobe, shutter and diaphragm used in an integrated image capturing device according to the present invention. In step 100, a CMOS sensor and a control circuit are integrated on a substrate. The control circuit comprises the photometry module 34, the calculating unit 38, the strobe control module 42, and the diaphragm-shutter control module 52 in FIG. 5. In step 110, a detecting flash is emitted for determining the reflection rate of the captured background. Step 110 can be ignored according to preferences of the manufacturer or the users. In step 120, the reflected light is received when the detecting light is reflected from the objects in the captured background. In step 130 the photometry of the reflected light and the light of the captured background are detected. In step 140, the diaphragm is adjusted and the shutter is opened with a proper exposure time according to the detected result of step 130. In step 150, the control circuit issues the controls to emit a flash with a flash period, flash brightness, and flash frequency.

In the prior art, a CCD sensor and a control chip fabricated in the CMOS technology cannot be integrated together. As for a digital camera with a CMOS sensor inside, the CMOS sensor and the control circuitry, seen as two independent modules, are still connected by wires. That a CMOS sensor and control circuitry in a digital camera are not integrated in one chip has the following disadvantages: 1. The procedure of packaging two independent modules is more complicated. 2. The transmission time between different modules limits the minimum of successive exposure interval. 3. Production time and cost are increased. Compared to the prior art, the present invention integrates the control circuit and the CMOS sensor together on a substrate during the manufacturing process. Transmission of electronic signals between each unit is fast and efficient, promoting the speed of successive photographing. Therefore, the present invention has the advantages of low hardware complexity, low cost, high quality of photos and high efficiency of processing in the digital camera.

Those skilled in the art will readily observe that numerous modifications and alterations of the device may be made while retaining the teachings of the invention. Accordingly, the above disclosure should be construed as limited only by the metes and bounds of the appended claims.

1. An integrated image capturing chip used in an image capturing device equipped with a strobe comprising:
a substrate;
a CMOS sensor mounted on the substrate for receiving an image signal; and
a control circuit mounted on the substrate comprising:
a photometry module for receiving a light signal of the image capturing device and detecting the photometry of the light signal;
a calculating unit connected with the photometry module for calculating a control parameter of a flash according to the photometry of the light signal; and
a strobe control module for controlling the flash according to the control parameter.

2. The image capturing chip of claim 1 wherein the control parameter comprises one or more of the following: brightness of the flash, a period of the flash, and a frequency of the flash.

3. The image capturing chip of claim 1 further comprising a memory for storing the image signal.

4. The image capturing chip of claim 1 further comprising an interface circuit for outputting an image signal.

5. An integrated image capturing device comprising:
a substrate;
an exposure module;
a CMOS sensor mounted on the substrate for receiving an image signal; and
a control circuit mounted on the substrate comprising:
a photometry module for detecting a light signal transmitted to the image capturing device and outputting a detection result;
a calculating unit connected with the photometry module for calculating an exposure control parameter according to the detection result; and
an exposure control module connected to the calculating unit for controlling the exposure module according to exposure control parameter.

6. The image capturing device of claim 5 further comprising a memory for storing the image signal.

7. The image capturing device of claim 5 further comprising an interface circuit for outputting an image signal.

8. The image capturing device of claim 5 further comprising a detecting flash for emitting a detecting flash.

9. The image capturing device of claim 8 wherein the photometry module is further used to control the detecting flash and detect a reflected light when the detecting flash is reflected by an object in the captured background.

10. The image capturing device of claim 5 wherein the exposure module further comprises a diaphragm and a shutter.

11. The image capturing device of claim 10 wherein the exposure control parameter comprises the size of diaphragm and the open period of the shutter.

12. The image capturing device of claim 9 wherein the calculating unit is further used to calculate a control parameter of a flash according to photometry of the reflected light.

13. The image capturing device of claim 12 further comprising a strobe control module connected to the calculating unit for controlling a flash according to the control parameter.

14. The image capturing device of claim 12 wherein the control parameter comprises one or more of the following: brightness of the flash, a period of the flash, and a frequency of the flash.
